(19) United States
(12) Patent Application Publication
(10) Pub. No.: US 2005/0030731 A1
(43) Pub. Date: Feb. 10, 2005

(54) Backlight module with integrated light guide plate and method for manufacturing the same

(76) Inventor: Wen-Feng Cheng, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/913,077

(22) Filed: Aug. 6, 2004

(30) Foreign Application Priority Data
Aug. 6, 2003 (TW) 92121568

(51) Int. Cl. F21V 7/04

(52) U.S. Cl. 362/31

(57) ABSTRACT

A backlight module (2) includes a frame (20), a light source (22) and a light guide plate(21). The light guide plate has a light-emitting surface (211), an incident surface (212), and a bottom surface. The frame accommodates the light guide plate and the light source. The light guide plate is integrated with the frame, because it is made from ultraviolet curable glues filled into the frame. The backlight module is simple, compact, and inexpensive to make.

### BACKGROUND OF THE INVENTION

1. Field of the Invention

The present invention relates to a backlight module and a method for manufacturing the same, and particularly to a backlight module used in a liquid crystal display and a method for manufacturing the same.

2. Description of Prior Art

In a typical liquid crystal display, a backlight module is used to provide a planar light source for illuminating the liquid crystal display. In general, the backlight module includes a light source and a light guide plate, the light source being located adjacent to one side of the light guide plate. The light guide plate transforms light beams emitted from the light source into planar light beams, and directs the planar light beams to a liquid crystal panel of the liquid crystal display.

A conventional backlight module, as shown in FIG. 13, includes a light guide plate 4, two light sources 5, two light source covers 6, a reflective plate 7 and a frame 8. The light guide plate 4 has two light incident surfaces 4A, a light-emitting surface 4B, a bottom surface 4C and a plurality of side surfaces (not labeled). A plurality of dots 9 is distributed on the bottom surface 4C, for improving the uniformity of light emission of the light guide plate 4. The two light sources 5 are located adjacent to the light incident surfaces 4A respectively. The light sources 5 may be cold cathode fluorescence lamps, light-emitting diodes or electroluminescent lamps. The reflective plate 7 is disposed between the bottom surface 4C and the frame 8, for improving the brightness of the backlight module 1. The frame 8 is made of resins, and is for protecting and fixing the light sources 5, the light guide plate 4, the reflective plate 7 and the light source covers 6 therein. Structures similar to the backlight module 1 are described in U.S. Pat. Nos. 6,163,350, 6,502,945, 6,513,943, 6,590,626 and 6,593,980.

The above-described backlight module 1 is usually assembled by hand. Typically, the assembly process is complex, time-consuming and costly. Moreover, the elements of the backlight module 1 are normally not compactly attached together, there being intervals created therebetween. Light beams emitted from the light sources are partly leaked through the intervals, and are not emitted from the light guide plate. The utilization of the light beams is reduced, and the distribution of brightness of the backlight module may not be uniform.

Automated assembly technology is gradually being introduced for backlight modules, supplanting traditional manual operations. However, the intervals remain a problem even at automated assembly lines.

An improved backlight module and a method for manufacturing the same that overcomes the above-mentioned disadvantages is desired.

### SUMMARY OF THE INVENTION

An object of the present invention is to provide a backlight module which has a simple and compact structure, and which is inexpensive.

In order to achieve the object set forth, a backlight module in accordance with one embodiment of the present invention comprises a frame, a light source and a light guide plate. The light guide plate has a light-emitting surface, an incident surface, and a bottom surface. The frame accommodates the light guide plate and the light source. The light guide plate is integrated with the frame, because it is made from ultraviolet curable glues filled into the frame. The backlight module is simple, compact, and inexpensive to make.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a backlight module according to a first embodiment of the present invention;

FIG. 2 is a schematic, cross-sectional view taken along line II-II of FIG. 1;

FIGS. 3 to 6 are similar to FIG. 2, but show successive stages in a preferred method for manufacturing the backlight module of FIG. 1;

FIG. 7 is an isometric view of a backlight module according to a second embodiment of the present invention;

FIG. 8 is a schematic, cross-sectional view taken along line VIII-VIII of FIG. 7;

FIGS. 9 to 12 are similar to FIG. 8, but show successive stages in a preferred method for manufacturing the backlight module of FIG. 7; and

FIG. 13 is a schematic, side elevation of a conventional backlight module.

### DESCRIPTION OF THE PREFERRED EMBODIMENTS

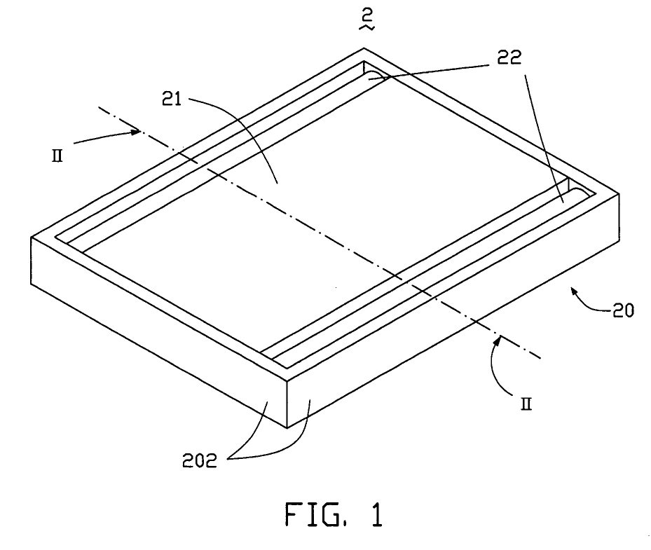

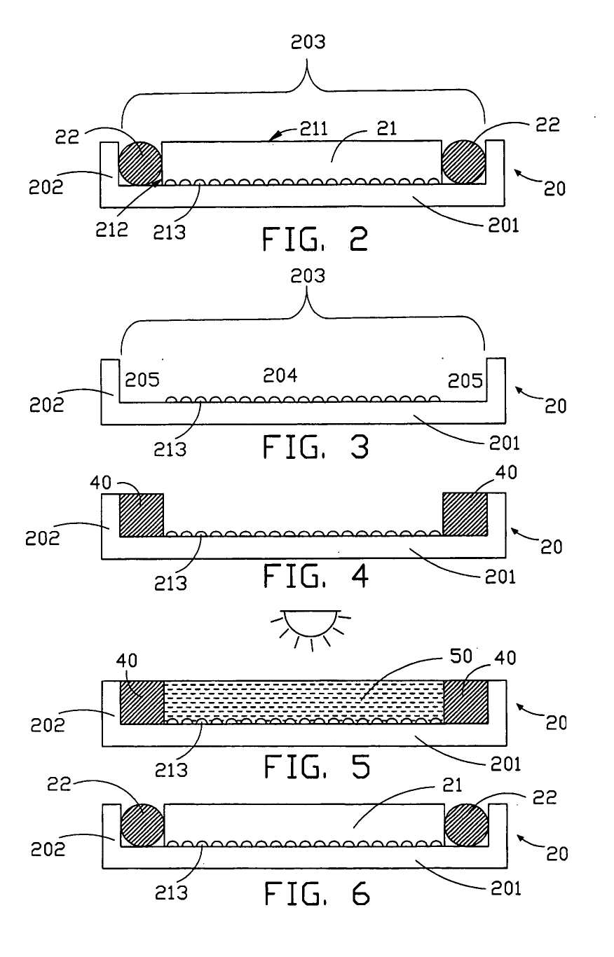

FIGS. 1 and 2 show a first embodiment of a backlight module according to the present invention. The backlight module 2 includes a mold frame 20, a light guide plate 21, and two light sources 22. The frame 20 is made of polycarbonate, which has a- high-reflectivity of 95 percent. The frame 20 includes a bottom wall 201 and four side walls 202. The bottom and side walls 201, 202 cooperatively define a generally rectangular space 203. The rectangular space 203 accommodates the light guide plate 21 and the light sources 22, with the light sources 22 being disposed at two opposite sides of the light guide plate 21 respectively. The light guide plate 21 is integrated with the frame 20, and includes a light-emitting surface 211, two incident surfaces 212, a bottom surface (not labeled) and a plurality of diffuser units 213 embedded in the bottom surface. The incident surfaces 212 face the two light sources 22, respectively. The diffuser units 213 can be an array of hemi-spherical diffusing particles, or alternatively comprise a series of parallel V-shaped grooves. In the illustrated embodiment, the diffuser units 213 are hemi-spherical diffusing particles.

FIGS. 3 to 6 illustrate stages in a method for manufacturing the backlight module 2 of the first embodiment. The manufacturing method includes the following steps:
(1) Providing the frame 20, as shown in FIG. 3. The rectangular space 203 of the frame 20 comprises a first area 204 having the diffuser units 213, and two second areas 205 at two opposite sides of the first area 204 respectively.
(2) Putting two parallelepiped stoppers 40 into the second areas 205, respectively, as shown in FIG. 4. Each of the parallelepiped stoppers 40 has a same volume as the corresponding second area 205. The parallelepiped stoppers 40 are made of steel. Each parallelepiped stopper 40 has a polished surface (not labeled) facing the first area 204. A roughness of the polished surface is less than 0.08 μm.
(3) Filling ultraviolet curable glues 50 into the first area 204, and illuminating the ultraviolet curable glues 50 with ultraviolet light (not labeled) for 10 to 20 sec. to form the light guide plate 21, as shown in FIG. 5. The ultraviolet curable glues 50 are transparent liquid materials, and the wavelength of the ultraviolet light is in the range from 200 to 400 nanometers.
(4) Removing the parallelepiped stoppers 40 from the second areas 205, and putting the light sources 22 into the corresponding second areas 205 to form the backlight module 2, as shown in FIG. 6.

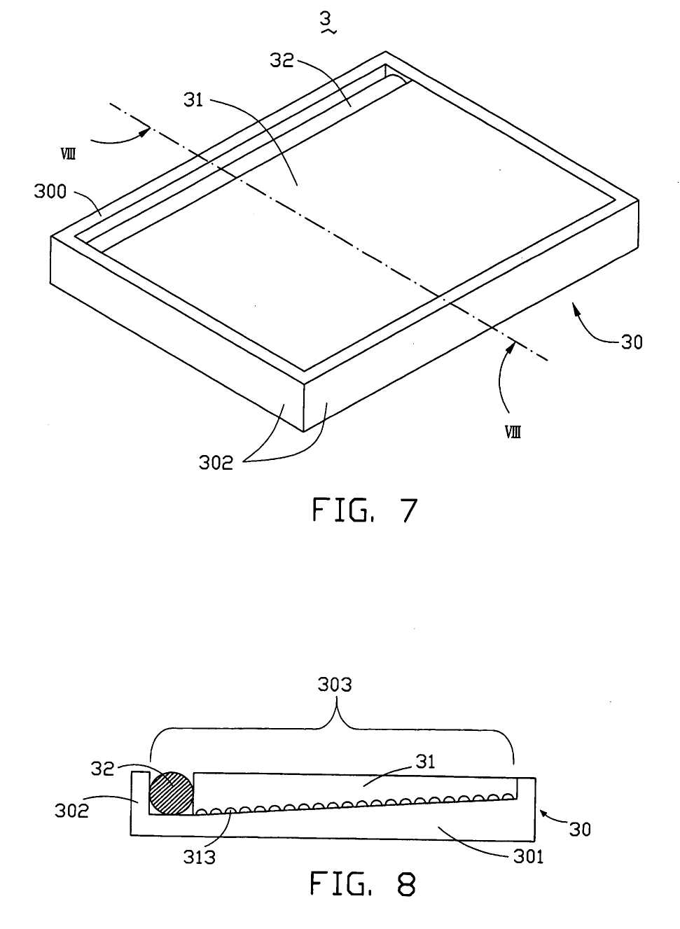

FIGS. 7 and 8 show a second embodiment of a backlight module according to the present invention. The backlight module 3 includes a mold frame 30, a light guide plate 31, and a light source 32. The frame 30 includes a bottom wall 301 and four side walls 302. The bottom and side walls 301, 302 cooperatively define a generally wedge-shaped space 303. The wedge-shaped space 303 accommodates the light guide plate 31 and the light source 32, with the light source 32 being disposed adjacent to the light guide plate 31. The light guide plate 31 is integrated with the frame 30, and includes a light-emitting surface 311, an incident surface 312, a bottom surface (not labeled) and a plurality of diffuser units 313 embedded in the bottom surface. The incident surface 312 faces the light source 32. The diffuser units 313 can be an array of hemi-spherical diffusing particles, or alternatively a series of parallel V-shaped grooves. In the illustrated embodiment, the diffuser units 313 are hemi-spherical diffusing particles.

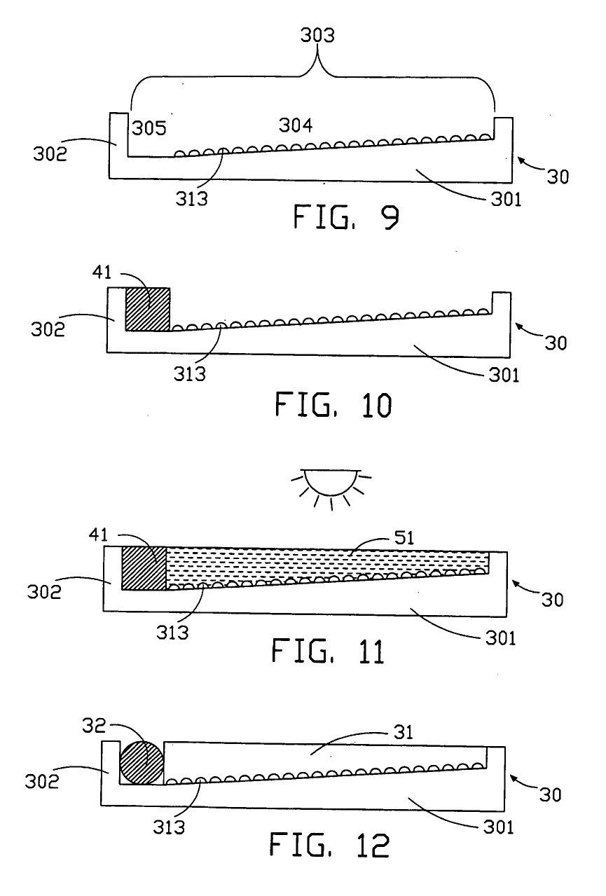

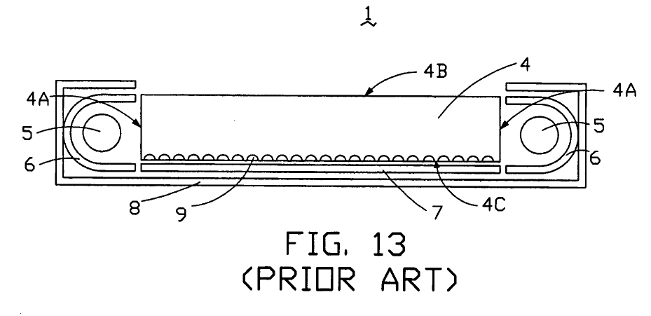

FIGS. 9 to 12 illustrate stages in a method for manufacturing the backlight module 3 of the second embodiment. The manufacturing method includes the following steps:
(1) Providing the frame 30, as shown in FIG. 9. The wedge-shaped space 303 of the frame 30 comprises a first area 304 having the diffuser units 313, and a second area 305 at one side of the first area 304.
(2) Putting one parallelepiped stopper 41 into the second area 305, as shown in FIG. 10. The parallelepiped stopper 41 has a same volume as the second area 305.
(3) Filling ultraviolet curable glues 51 into the first area 304, and illuminating the ultraviolet curable glues 51 with ultraviolet light (not labeled) to form the light guide plate 31, as shown in FIG. 11.
(4) Removing the parallelepiped stopper 41 from the second area 305, and putting the light source 32 into the second area 305 to form the backlight module 3, as shown in FIG. 12.

In the above-mentioned backlight modules 2, 3, there are no intervals between the light guide plate 21, 31 and the frame 20, 30 because the light guide plate 21, 31 is integrated within the frame 20, 30. Thus the utilization of light is high. Further, because the frame 20, 30 is made of polycarbonate with a high reflectivity, there is no need for additional reflectors and/or light source covers. Therefore, the backlight modules 2, 3 each provide a simple and compact structure at a correspondingly low cost.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claim are expressed.

1. A backlight module, comprising:
a frame;
a light source; and
a light guide plate having a light-emitting surface, an incident surface, and a bottom surface;
wherein, the frame accommodates the light guide plate and the light source, and the light guide plate is integrated with the frame.

2. The backlight module according to claim 1, wherein the frame is made of polycarbonate.

3. The backlight module according to claim 1, wherein the frame defines a generally rectangular space.

4. The backlight module according to claim 1, wherein the frame defines a wedge-shaped space.

5. The backlight module according to claim 1, wherein the light guide plate has a plurality of diffuser units embedded in the bottom surface.

6. The backlight module according to claim 5, wherein the diffuser units are diffusing particles.

7. The backlight module according to claim 5, wherein the diffuser units comprise V-shaped grooves.

8. The backlight module according to claim 1, wherein the light guide plate is made from ultraviolet curable glues.

9. A method for manufacturing a backlight module, comprising the following steps:
providing a frame defining a first area and at least one second area;
putting at least one stopper into said second area;
filling liquid type material into the first area, and successively hardening said material to form a light guide plate; and
replacing said stopper with at least one light source in said second area to form the backlight module.

10. The method according to claim 9, wherein said stopper is parallelepiped, said material is ultraviolet curable glues, and the hardening step is implemented by illuminating the ultraviolet curable glues with ultraviolet light.

11. The method according to claim 10, wherein the combined first and said second areas is a generally rectangular space.

12. The method according to claim 10, wherein the combined first and said second areas is a wedge-shaped space.

13. The method according to claim 10, wherein the first area has a plurality of diffuser units.

14. The method according to claim 13, wherein the diffuser units are diffusing particles.

15. The method according to claim 13, wherein the diffuser units comprise V-shaped grooves.

16. The method according to claim 10, wherein the said parallelepiped stopper has a polished surface.

17. The method according to claim 10, wherein the ultraviolet curable glues are transparent liquid materials.

18. The method according to claim 10, wherein the frame is made of polycarbonate.

19. A backlight module, comprising:
a frame defining an upward cavity with reflection characters thereon;
a light source located inn one portion of the cavity; and
a light guide plate located in other portions of the cavity; wherein
the frame functions as molds to form the light guide plate therein, and thus the formed light guide plate is snugly and compliantly received within the frame.
